(19) United States
(12) Patent Application Publication
(10) Pub. No.: US 2013/0257373 A1
(43) Pub. Date: Oct. 3, 2013

(54) CABLE HANDLING SYSTEM

(71) Applicants: John M. Mallon, IV, Wakefield, RI (US); Norman B. Holden, Warwick, RI (US)

(72) Inventors: John M. Mallon, IV, Wakefield, RI (US); Norman B. Holden, Warwick, RI (US)

(21) Appl. No.: 13/796,130

(22) Filed: Mar. 12, 2013

Related U.S. Application Data
(60) Provisional application No. 61/609,605, filed on Mar. 12, 2012.

(51) Int. Cl. B60L 11/18; F16L 3/16

(52) U.S. Cl. CPC B60L 11/1824; F16L 3/16
USPC 320/109; 248/65; 320/137

(57) ABSTRACT

A cable handler device has an elongated arm pivotally attached to a base, such that the arm is adapted to move in proximity to a charge receptacle, and a cable secured to the arm, the cable having a charge connector adapted to engage the charge receptacle. The cable has a fixed portion secured substantially parallel to the elongated arm and a free portion extending from a distal end of the elongated arm, and the charge connector is disposed suspended at an end of the free portion. A cantilever support maintains the elongated arm biased in an upward position, such that the cantilever support reduces external force needed to pivot the arm and a range of the pivot of the elongated arm disposes the charge connector above ground level such that the free portion avoids ground contact during engagement of the charge connector and charge receptacle.

### RELATED APPLICATIONS

This application claims the benefit of priority under 35 U.S.C. §119(e) to U.S. Provisional Patent Application No. 61/609,605, filed Mar. 12, 2012, entitled “CABLE HANDLING SYSTEM,” the teachings of which are incorporated herein by reference in entirety.

### BACKGROUND

Dependence on petroleum and other fossil fuels has focused much attention on hybrid and electric vehicles for mitigating petroleum demand. Electrically powered vehicles employ on-board electric storage (batteries) for accumulating and storing reserve electrical energy. While hybrid vehicles recoup some electric energy from a supplemental gasoline engine, a physical electrical connection to an external electric source is often employed for both hybrid and dedicated electric vehicles. While electric vehicle users typically employ a charging station at a residence or garage, public charging stations are becoming increasingly popular as the number of electric vehicles increases. Such public charging stations increase the effective range of an electric vehicle, and eliminate charging downtime by recharging batteries when the car would otherwise be parked and unused anyway.

Charging stations provide a common facility to connect an electric vehicle to a charge source, typically through a plug and connector similar to household appliances. Evolving standards and practices concerning charging stations are promulgated by industry leaders, including vehicle manufacturers, public utilities, governmental agencies, and charge station manufacturers. Widespread deployment of charging stations is expected to occur as electric vehicles increase in popularity and sales, facilitated by a symbiotic association to increased availability of charging stations. In other applications outside of the car charging market, temporary use of cables/hoses to work on or to connect to devices for building, repairing, testing, cleaning or packaging requires a safe method of handling the hoses and cables overhead to protect personnel and equipment in proximity to the device

### SUMMARY

In a general sense, temporary cable connections such as electric vehicle charge cables often provide coupling of fluid, electrical and mechanical system between entities that supply or consume them, such as charging stations for electrically powered vehicles. Such temporary cable systems must maintain resilience of the cables to pedestrian traffic, vehicular traffic, weather, and other environmental and contextual hazards that might undermine the effectiveness of the cable/hose and connector system. When connecting cables or hoses to a device on a non-permanent basis, the cables and hoses are often run on the ground which creates a trip hazard and potential electrical shock or exposure risk to high-pressure gases or fluids that may be contained therein. The cable/hose are also subject to damage or contamination by dropping or coming in contact with the ground as well as becoming pinched or damaged by devices in the work zone. It should be noted that the cable as defined herein refers to any flexible conduit for materials and/or energy that may be suspended and temporarily engaged for transfer of the materials and/or energy, such as a hose, tubing, flexible pipe, wire and other suitable materials.

An overhead pivoting cable or hose handling system to elevate the cable/hose in the work area of the device maintains the cable/hose above ground level to prevent hazards to people moving the cable/hose or when in proximity of the cable/hose and prevents damage to the cable/hose from contact with the ground, objects or people. The cable handling system provides seamless disconnection and retraction to a rest position when not in use, avoiding the burdensome requirements of conventional approaches in setting up and dismantling typical temporary cable arrangements.

Configurations disclosed herein safely maintain the cable or hoses overhead when connected and then pivots to retract and conserve space when the device is not in use. Common uses for this configuration would be for vehicles, machinery or other machinery or devices needing air, electricity or other fluid on a temporary basis such as assembly, testing, charging, servicing or powering a machine where it is unsafe to supply the machine directly from existing overhead or underground or on nearby structures.

A particular use of this configuration is for electric vehicle (EV) charging systems located inside or outside parking areas. The configuration is particularly suited to outdoor use as its mechanisms are resilient well suited to withstand environmental effects like rain, snow, ice and wind. The internal cable or hoses in the main pole are also protected from environmental elements.

In the case of an electric vehicle (EV), most EV charging stations have a cable with a connector that is hung on the station. When using the station, the cable is taken off of the holder on the station and plugged into the vehicle. The cable is dragged on the ground, gets dirty or chafed and creates a safety hazard for anyone passing between the station and the vehicle. The cable is likely not to be placed back properly onto the charging station after use. Local regulatory or governmental agencies may be reluctant to permit existing charging stations with a high likelihood of trip hazards. Most existing charge stations are not ADA compliant because the charge cable, when connected, is disposed on the ground and located in the path of travel for disabled users. If the cable is not returned properly to the charging station, it may not be within reach of subsequent disabled users. When the user brings the cable to the vehicle, the cable can scratch the car or get stuck underneath it. If the cable is left on the ground after charging, it is a safety issue to people, or to the station or the cable/connector may be run over by other vehicles. Since charging can take anywhere from 10 minutes to 8 hours or more, the vehicle is unattended and the hazards are present for an extended time period. In cases where the vehicle is used to send power back into the electrical grid (smart grid), the vehicle will need to be plugged in for extended periods unattended.

Configurations herein are based, in part, on the observation that conventional deployment of a charge cable for an electric vehicle require deployment of a large heavy cable from a curbside mounting to a charge receptacle on the vehicle. Depending on the parked location, the charge cable may need to be disposed around the front or back of the vehicle for connection to a charge receptacle on the vehicle.

Unfortunately, conventional approaches to electrical vehicle charge connections suffer from the shortcoming that little consideration is given to handling, storage, and manipulation of the cable during hookup to an electric vehicle. Charge cables are dragged on the ground around a vehicle to access the charge receptacle, remain in ground contact during the charge cycle connection, and rely on the tidiness of the user to restore the charge cable to a coiled or looped storage position. For example, as an illustration of human nature, it is common to observe a pubic (common use) tire inflation dispenser at a gasoline retailer. The air hoses may often be observed strewn on the ground around the dispenser, rather than coiled back onto a hook provided for this purpose. In the case of electric vehicles, however, the cables carry high voltage rather than simply compressed air. A compromised cable presents a safety hazard. Conventional deployments allow for cables to remain resting on a ground surface between and during usage, where physical abrasion, moisture, and contact or impact from passing vehicles or pedestrians is likely.

In alternate configurations, the charge connector is a coupling and the receptacle is responsive to conductive, inductive, fluidic or other communication with the coupling. The cable may be a conduit or hose for transport of fluids such as gaseous or liquid fuels or other materials, in addition to transfer of electric charge for charging the batteries of an EV.

Configurations herein substantially overcome the shortcomings of charge cable handling by deploying the charge cable along a cantilevered arm for offsetting the weight of the cable while extending over the vehicle in a pivoting, rotational manner from a base, therefore requiring minimal displacement force from a user to manipulate the arm proximate to a charge receptacle on a vehicle. The cantilevered arm deploys the cable above ground level such that a user engages a charge connector, at the end of the charge cable, with the charge receptacle while avoiding ground contact of the cable and connector throughout the deployment and engagement.

In further detail, in a particular configuration, the cable handler device as disclosed herein includes an elongated arm pivotally attached to a base, such that the arm is adapted to move in proximity to a charge receptacle, and a cable secured to the arm, the cable having a charge connector adapted to engage the charge receptacle. The cable has a fixed portion secured substantially parallel to the elongated arm and a free portion extending from a distal end of the elongated arm, and the charge connector is disposed suspended at an end of the free portion. A cantilever support between the arm and the base supports the elongated arm in an upward biased position, such that the cantilever support reduces external force needed to pivot the arm, and a range of the pivot of the elongated arm disposes the charge connector above ground level such that the free portion avoids ground contact during engagement of the charge connector and charge receptacle.

Some existing charging stations have short cables to limit potential safety issues and cable damage so it is difficult to reach all points on a vehicle in the charging spot, or space where the charging vehicle is parked. The vehicle may have to be positioned in specific orientations around the charge station making the station inconvenient. The configuration disclosed herein allow safe charging of the vehicle by providing access to any point on the car regardless of orientation into the charge spot or the ability to service multiple charge spots around the charging station.

Charging stations are being installed into the existing public infrastructure, where space intrusions are delicate and must be visually pleasing. In addition, most existing infrastructure poles have been designed to carry loads and to withstand wind loads with the original use in mind and are not able to hold much more additional weight or wind force profile. This configuration retracts to a very small footprint, has low surface area for wind to act on and has a small visual impact. The configuration can also be mounted to existing poles, lights, and parking meters etc. because it is very light and consumes little space when not in use. Installation costs are low as no additional foundations or base structures are required.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is a context diagram of a charging environment of an electric vehicle (EV);

FIG. 1B is a perspective view of the EV of FIG. 1A;

FIG. 1C is a perspective view of the work envelope around the receptacle/charging vehicle;

FIG. 2A is a side elevation of the main assembly;

FIG. 2B is a front elevation of the main assembly;

FIG. 2C is a front elevation of the pivotal attachment;

FIG. 2D is a side elevation of the pivotal attachment;

FIGS. 3A-3D show progressive pivoting of the elongated arm through a range of pivot;

FIGS. 4A-4D show routing of the charge cable in the main assembly of FIG. 2A;

FIGS. 5A-5D show an example of a stand alone mounting base of the main assembly of FIG. 2A;

FIGS. 6A-6C show the gas shock counterbalance of the cantilever support of FIG. 3A in more detail;

FIG. 6D and 6E shows a linear drive mechanism of the cantilever support of FIG. 1A.

FIGS. 7A-7B show the rotation plate of FIG. 5A in more detail;

FIG. 8A-8B show a wall mount indoor configuration of the cantilever support as an alternative to FIG. 5A; and

FIG. 9 shows a flowchart of deployment of the cable handling device for charging a battery of an electric vehicle, as disclosed above.

### DETAILED DESCRIPTION

Depicted below are example configurations. Particular components of the disclosed configurations include an upright self-retracting pole with a connected coiled cable or hose. The pole will be mounted to a rotary base or onto an existing pole with a rotary collar so the pole can be moved to a position for use. When pivotally retracted, the device consumes minimal space and will not impede the movement of people machinery or vehicles with in its working envelope. The cable handler device can carry a multiple of hoses, cables or a combination, and may be employed for a variety of physical, mechanical or electrical uses. The cable is adapted for communicative transfer via the interface, such as electrical (charging source for a vehicle), fluids (e.g. fuel, compressed air) or controls (e.g. tethered pendant control). Further, the transfer may engage a connector to a receptacle through a physical locking arrangement, or may communicate via a proximity association, such as an inductive charger or a gravity driven fluid. The examples discussed below depict an electric vehicle charge system as an illustrative usage, although any arrangement of coupling for a communicative transfer benefits from the disclosed cable handling. Disclosed configurations are effective for outside use due to a simple design resistant to rain, snow, ice build up etc. The cable handler device minimizes effects of high winds as it has a very low wind profile and uses bendable or compliant mechanisms.

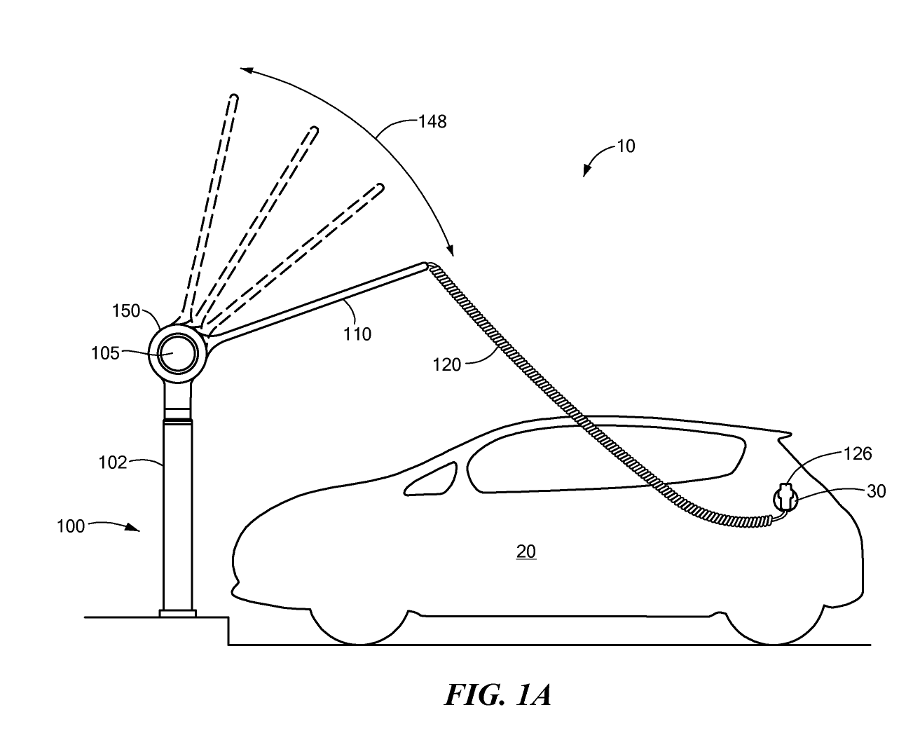

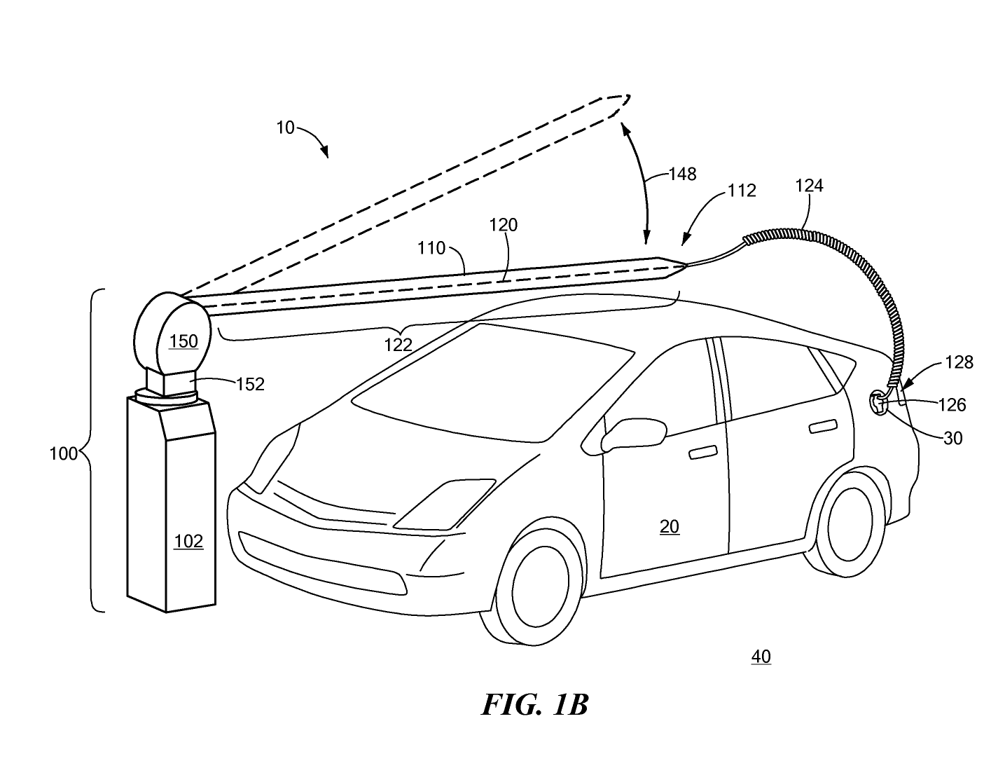

FIG. 1A is a context diagram of a charging environment 10 suitable for use with an electric vehicle (EV) 20, and FIG. 1B is a perspective view of the EV of FIG. 1A. Referring to FIGS. 1A and 1B, the EV 20, which may be a hybrid vehicle having supplemental propulsion or exclusively electric propulsion, is parked or otherwise disposed adjacent to a cable handler device 100, such as a charge cable handler for an electrical vehicle charging station. An elongated arm 110 attached to a cantilever support 150 mounted on top of a mounting post 102 pivots downward through a pivot range 148 to dispose the charge cable (cable) 120 such that a charge connector 126 is adjacent to a charge receptacle 30 of the vehicle 20. Further, alternate configurations may employ an inductive rather than a conductive charge connector to relax the rigidity and distance of the charging coupling.

As will be discussed further below, the cantilever support 150 counterbalances the weight of the elongated arm (arm) 110 and cable 120 such that very little force need be exerted by a user to dispose the elongated arm 100 through the pivot range 148. A rotational coupling 152 permits rotation of the cantilever support 150 for moving the elongated arm 110 into proximity of the charge receptacle 30. The elongated arm 110 may also include an articulated coupling on the elongated arm 110, in which that the articulated coupling is operable to dispose the charge connector 126 to the charge receptacle 30 such that the free portion 124 remains suspended between the elongated arm and the charge receptacle 30. Maintaining the charge cable 120 in an elevated, above ground manner protects cables from ground, contamination, chafing/abrasion, dirt, snow and ice etc. protects against trip hazards to passersby, and also avoids vehicles running over the cable 120, as well as preserving end connectors/fittings from damage and contamination.

Once disposed or drawn into position, the user engages the charge connector 126 to the charge receptacle 30 to establish electrical communication and complete the charging circuit for the batteries of the EV 20. Alternatively, the elongated arm 110 may be employed for other electric or fluidic connections. A further advantage is that elevation of the cable mitigates extreme hot and cold temperatures that impede user operation, for example requiring the user to coil the cable back on the station (e.g. hot cable sitting in direct sunlight is hot to touch) or where cable/hose reels are used and are unable to reel a hot cable and a cold cable will not flex for recoiling.

A display screen 105 may render commercial, technical or operator feedback, as well as an additional user display on the mounting assembly, discussed further below.

FIG. 1C is a perspective view of a work envelope 160 around the receptacle/charging vehicle, shown by dotted lines 162. The work envelope 160 is defined by receptacle 30 locations serviceable (within range of the connector 126) based on the pivot range 148 and a rotation arc 149 of the rotational coupling 152. In the case of an EV 20, the work envelope 160 is the area into which the EV need position the charge receptacle 30 in order to allow charging from a charging station employing the cable handling device herein. The work envelope 160 therefore includes a range of travel of the charge connecter 126, tethered from the elongated arm 110, throughout a full pivot range 148 of the arm and a full range of the rotational arc 149.

In contrast to conventional approaches, in which connecting an EV 20 on a traffic side of the EV opposed to the curbside charging station would leave the charge cable resting or dragging on the ground, the work envelope 160 is elevated above ground level and extends fully around the EV. Current UL (Underwriters Laboratories) guidelines limit cable length to 25 feet, which may be insufficient to reach around larger vehicles, or may burden the user with rerouting a free-laying cable by dragging around the vehicle.

The charge cable 120 terminates at the charge connector 126 which is tethered to a distal end 112 of the elongated arm by a free portion 124 of the charge cable 120. The charge cable 120 also has a fixed portion 122 attached parallel to the elongated arm 110. Therefore, the bounds of the work envelope 162 are defined by the range of movement of the elongated arm 110 through the pivot range 148 and rotational arc 149 and a range of movement of the free portion 124.

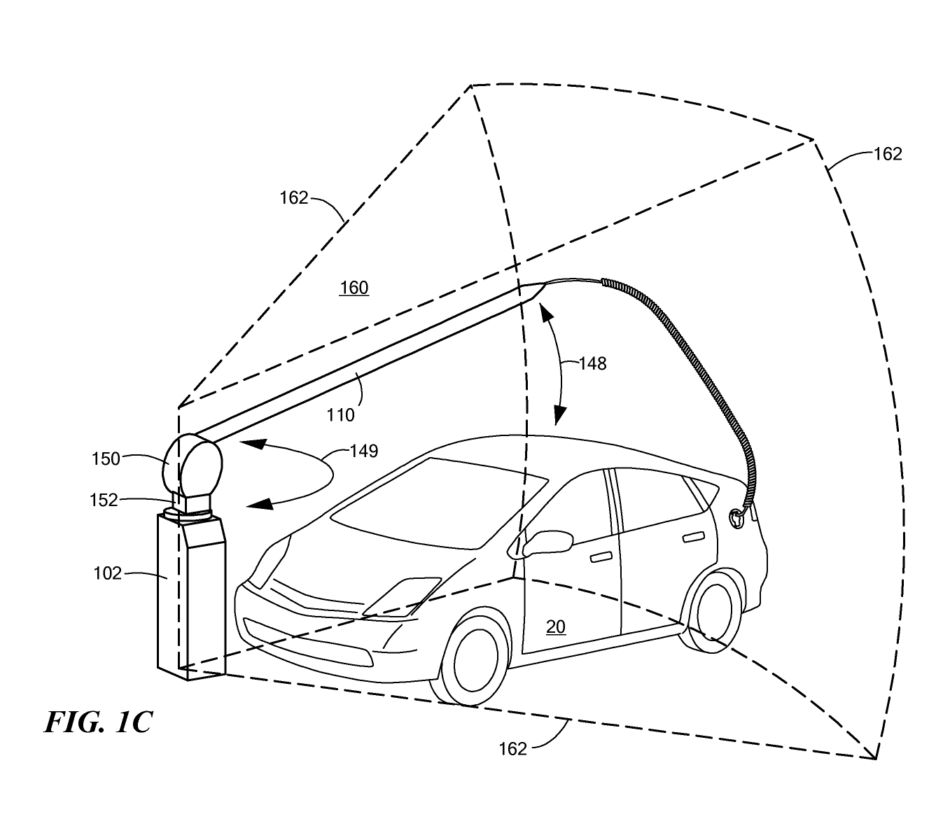

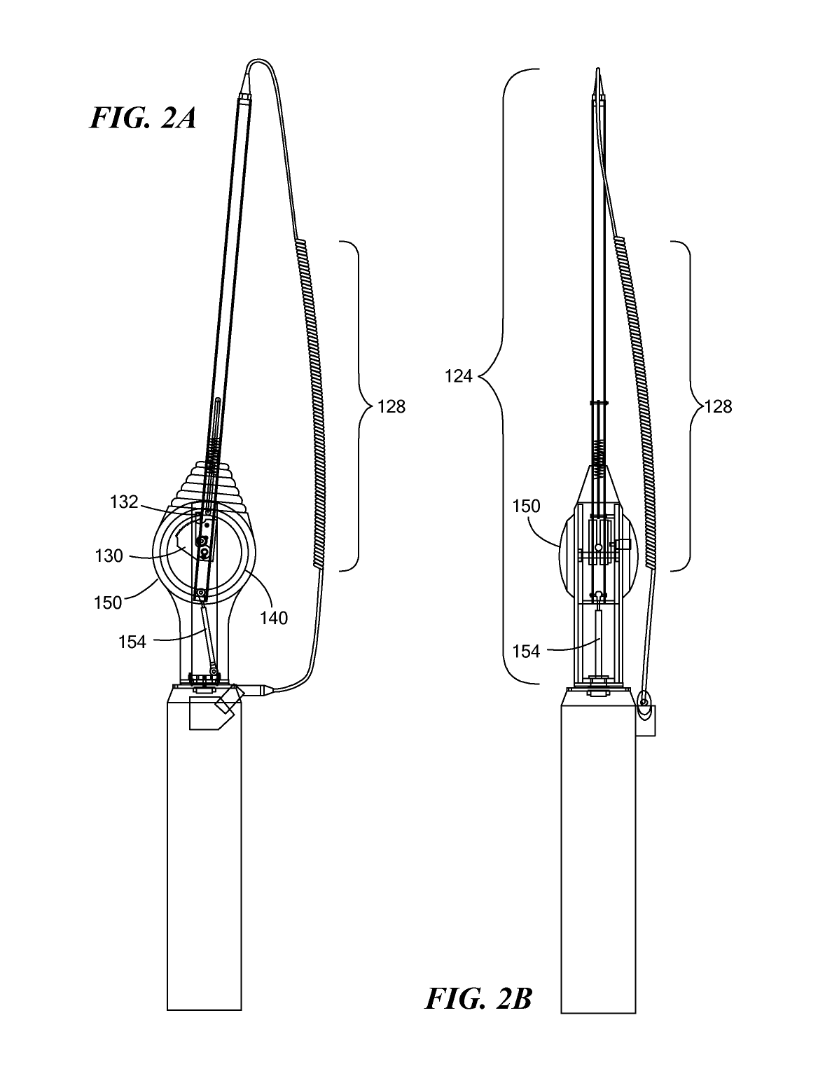

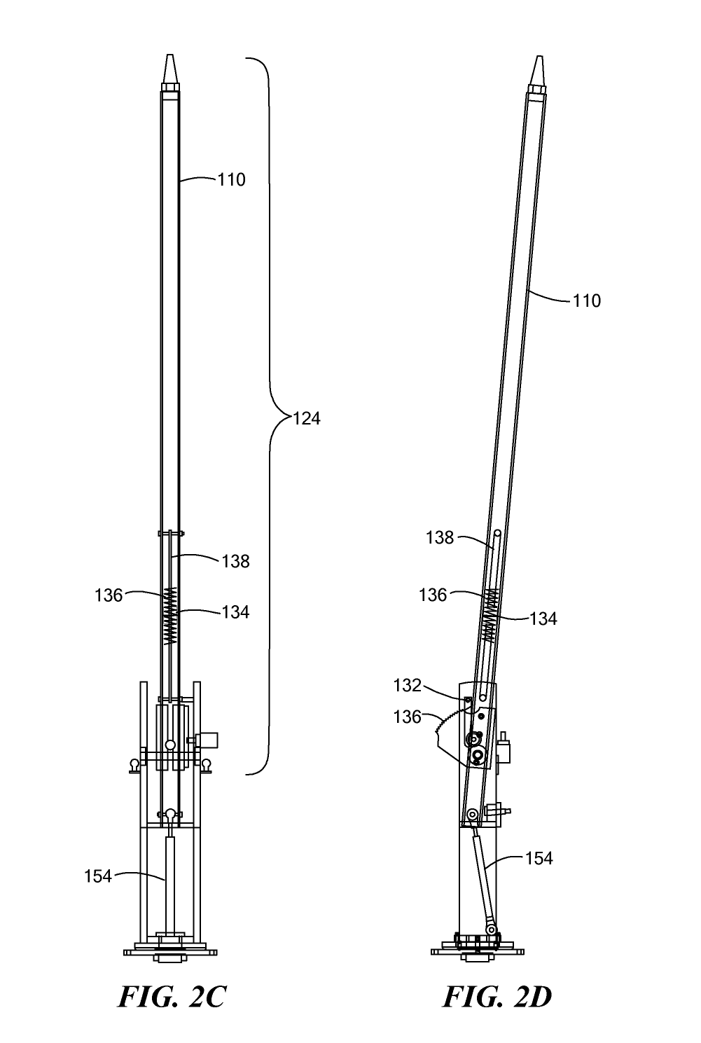

FIGS. 2A-2D show elevation views of the cable handler device 100. FIG. 2A is a side elevation of the main assembly, FIG. 2B is a front elevation of the main assembly, FIG. 2C is a front elevation of the pivotal attachment, and FIG. 2D is a side elevation of the pivotal attachment. Referring to FIGS. 1A-1C and 2A-2D, in a particular arrangement, the cantilever support 150 includes a counterbalance 154, such as a gas spring for offsetting the weight of the elongated arm 110. The counterbalance 154 exerts a force slightly greater than the weight of the elongated arm 110 and charge cable 120 such that a slight upward bias is maintained in the elongated arm 110. A rotation track 140 accommodates rotation of the mounting for the elongated arm 110 to provide the pivoting movement. The cantilever support 150 may therefore include a fluidic pressure driven shaft coupled to the arm adjacent to the pivot attachment at a proximate end of the arm 110 for providing upward force. Alternatively, the cantilever support 150 may include a motor driven worm gear such as a linear actuator, in which that the motor is responsive to user commands for pivoting the elongated arm 110. Alternate configurations may include, for example, a spring loaded side detents or motorized gear mechanism for the counterbalance 154 or frictional clutch mechanisms.

The counterbalance 154 delivers a force substantially equal to the downward gravitational force exerted on the elongated arm 110 such that a user need exert little additional force for disposing the elongated arm 110 through the pivot range 148 for raising and lowering the elongated arm 110 and engaging the charge connector 126 with the charge receptacle 30. The force exerted on the elongated arm 110 includes the weight of the free portion 124, thus the counterbalance 154 upward force accommodates this load. Further, as the free portion 124 is not expected to rest on the ground 40, the counterbalance 154 may impart a slight upward bias to the elongated arm 110 such that the elongated arm 110 returns to an upright rest position when idle. In certain configurations, the elongated arm 110 may also include a complementary electronic accessory such as a light, camera or signal (i.e. light) for providing feedback to passersby or a remote security monitoring station.

The free portion 124 may include a coiled section 128 for increasing the work envelope 160 while still limiting at-rest length of the cable 120. A position locking cam 130 and cam dog 132 impart ratcheted or selectively resistant force to the elongated arm 110 for fixing a position appropriate to the vehicle 20 and charge receptacle 30 position.

A breakover coupling 134 maintains the elongated arm 110 rigid until a predetermined quantum of force is applied. The breakover coupling 134 maintains the rigid coupling until the excessive force is applied, defined by a coupling spring 136. Following deployment (i.e. expansion of the spring 136), the elongated arm 110 returns to the rigid coupled state upon cessation of the excessive force by retraction of the coupling spring 136. In the event of a greater disconnective forces, such as a motorist attempting to drive away with the charge connector 126 still engaged, a breakaway attachment 138 is adapted to provide a predetermined point of detachment of the elongated arm at the same point as the breakover coupling 134. In the example configuration, the breakaway attachment is implemented as a spring anchor such as a cord having a predetermined maximum tension, such that the cord severs after the maximum tension is reached. The point of detachment selectively severs the elongated arm upon excessive pressure, such that the selective severing includes a clean disengagement of electrical conduction such that electrical terminals are unexposed.

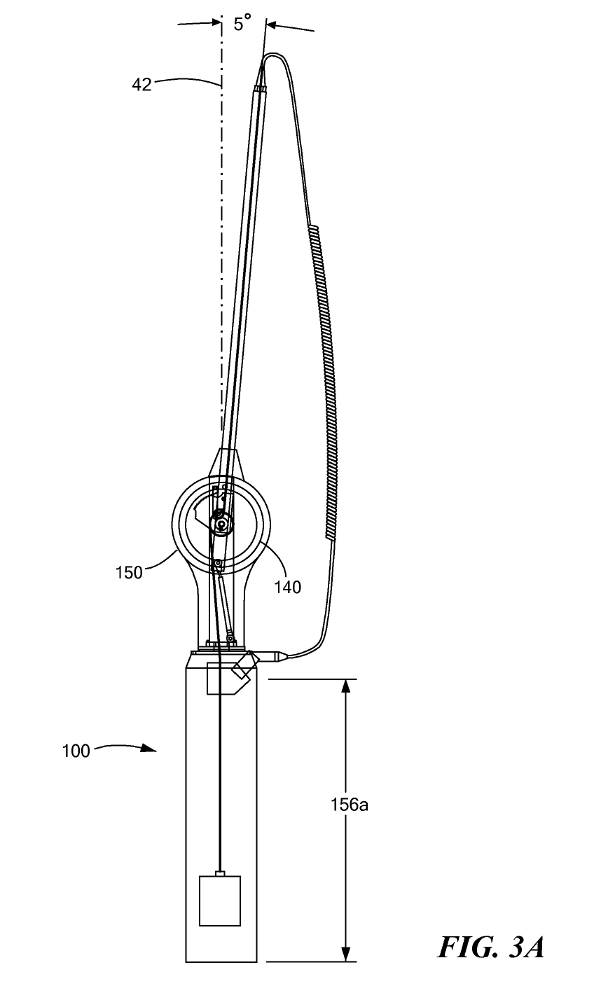

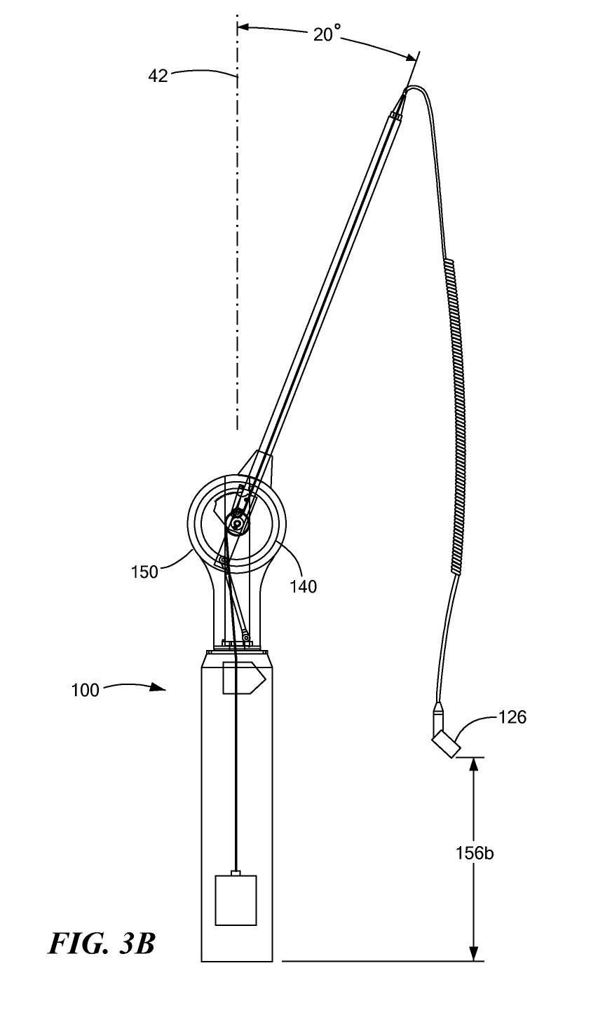

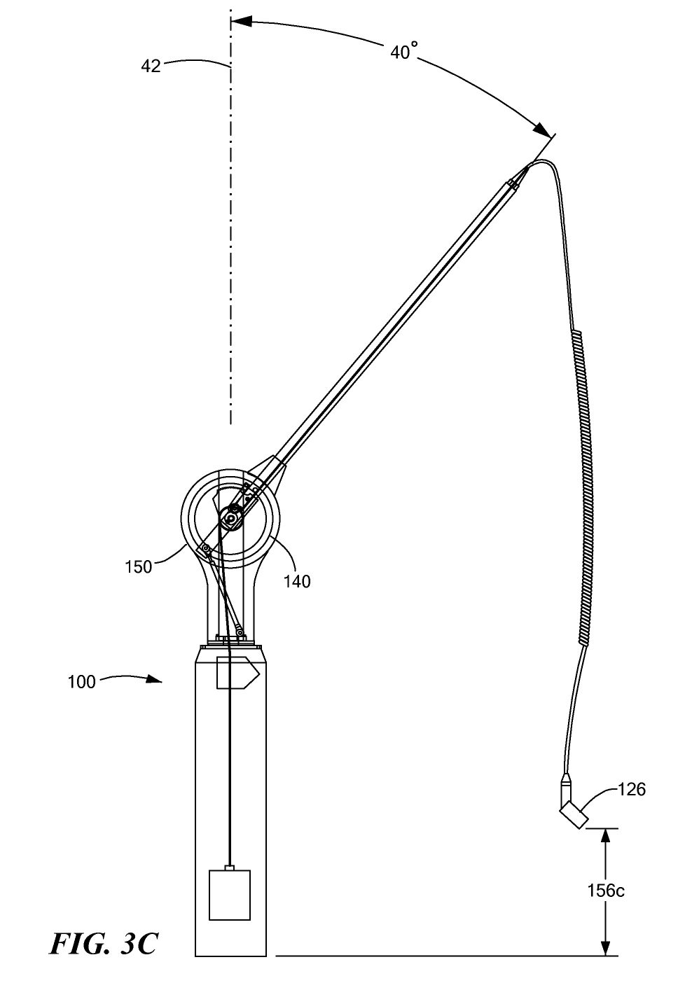

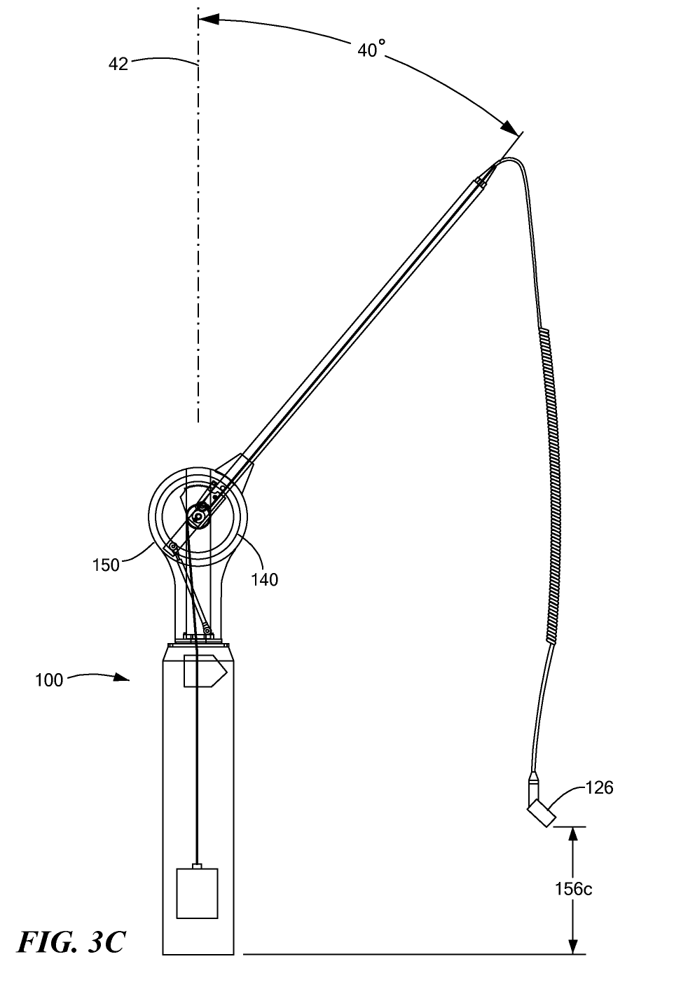

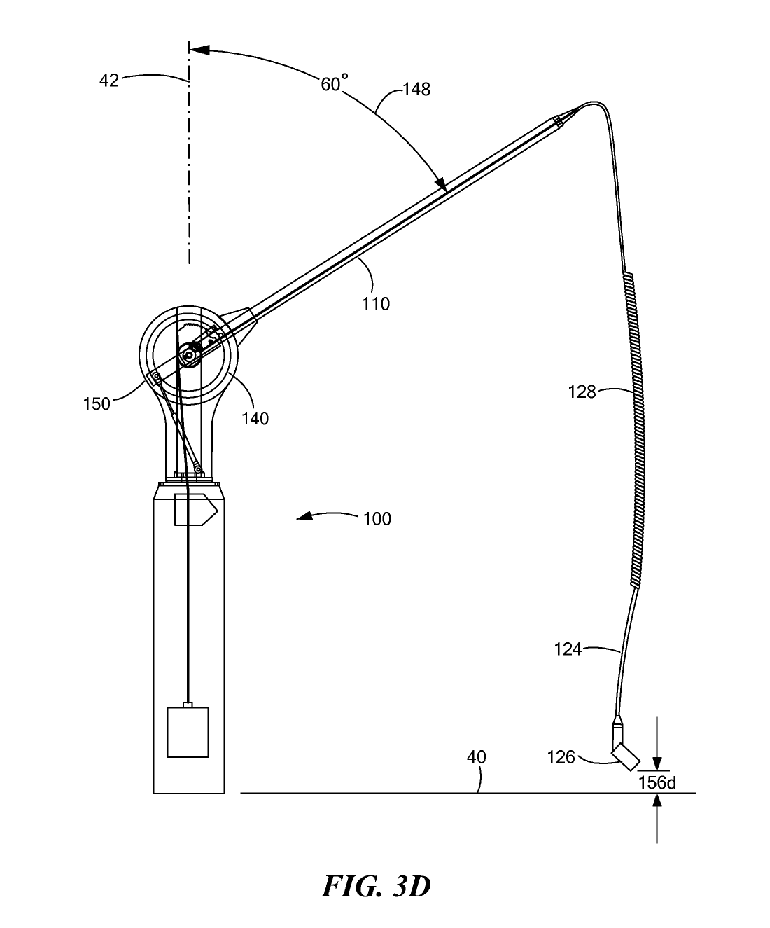

FIGS. 3A-3D show progressive pivoting of the elongated arm through a range of pivot. Referring to FIGS. 3A-3D and continuing to refer to FIGS. 1A-1D and 2A-2D, FIG. 3A shows the elongated arm 110 at a rest position at the vertical extreme of the range 148, substantially around 5° from vertical (dotted line 42). As a user draws the elongated arm 110 downward by pulling the charge connector 126 towards the charge receptacle 30, the cable approaches 20°, shown in FIG. 3B. Such a position may be sufficient for a receptacle mounted on the side of the EV 20 facing the cable handler device 100 (i.e. on the curb side). If a charge receptacle 30 is centered along a width of the car, such as behind a rear license plate or centered on the hood, the elongated arm 110 may be disposed around 40°, shown in FIG. 3C. The pivot is operable to raise and lower the arm 110 for extending the distal end 112 and the free portion 124 outward from the base for disposing the free portion 124 proximate to the charge receptacle 30 for engaging the charge connector 126.

For a charge receptacle 30 mounted on the opposite side if the EV 30 from the cable handler device 100, the elongated arm 110 may be fully extended to the horizontal extreme of the range 148, as shown in FIG. 3D, allowing the charge cable 120 and free portion 124 to swing over the EV 20 to reach the receptacle, substantially at around 60°, although the angle of elevation may vary, with the intent being to maintain the charge connector 126 above ground 40 level from the length of the free portion 124. In other words, in a particular configuration, the height of the distal end 112 of the elongated arm 110 is greater than the length of the free portion 124 when the coiled portion 128 is unexpanded.

The actual distance may vary; in the example arrangement the various heights of the charge connector 126 are shown as elevated distance 156a-156d, corresponding to FIGS. 3A-3D respectively. The free portion 124 is sufficiently limited in length such that ground contact is avoided when the arm 110 is disposed to a maximum lowered position. The free portion 124 therefore remains suspended throughout a combined range of the pivot 148 and a range of the rotational coupling 152. Further, for users with disabilities, and/or in accordance with ADA (Americans with Disabilities Act) the connector is kept in the ADA mandated height zone for disables people, for example the ADA mandates accessibility 15-48 inches off the ground 40.

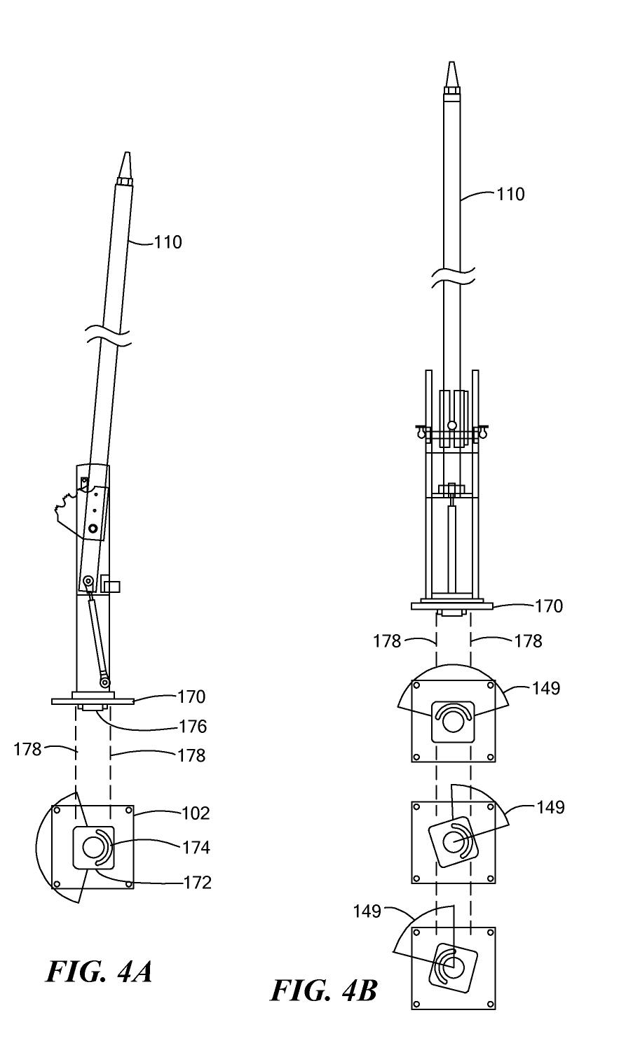

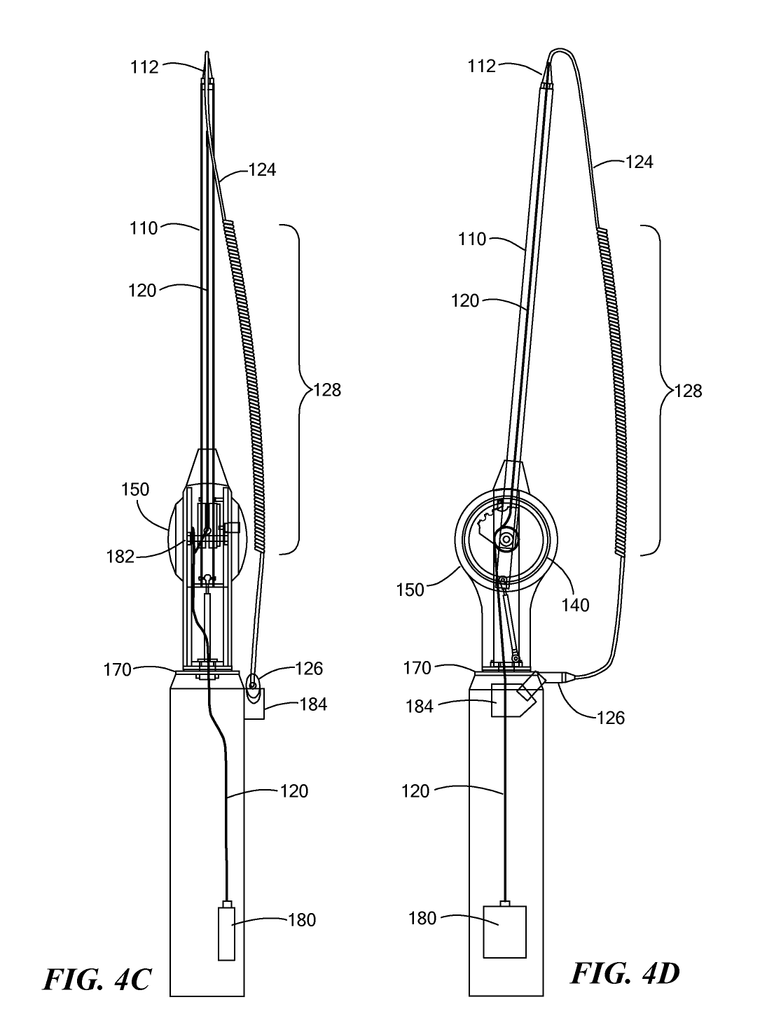

FIGS. 4A-4D show routing of the charge cable and rotation of the cantilever support 150 in the main assembly of FIG. 2A. Referring to FIGS. 4A-4D, a rotation plate 170 supports the cantilever support 150, and rests on top of a base plate 172 on top of the mounting post 102. A pivot knob 176 or similar protrusion extends from the rotation plate 170 for engagement with a rotation receptacle 174 defined by a recess in the base plate 172, as shown by insertion lines 178. The pivot knob 176 and rotation receptacle 174 define the rotation arc 149 of movement of the cantilever support 150. Generally, any suitable arc range may be provided, for example a curbside mount may benefit from rotation only 180° on the street site so as not to interfere with pedestrian traffic, for example. In particular configurations, a limit of just short of 360° may be imposed to avoid circular rotation that could twist the change cable 120, discussed below in FIGS. 4C-4D.

In FIGS. 4C and 4D, the routing of the charge cable 120 is shown. The cable 120 emanates from a grid connection 180, typically represented by a standard local supply (i.e. 120/240V, 50-60 Hz, depending on region), and may perform other transformation for achieving suitable voltage and current for the EV 20. The grid connection 180 may also be employed for delivering excess power from the EV 20 back to the grid. The cable 120 extends up through the rotation plate 170 and around a central spindle 182 of the cantilever support 150. The central spindle 182 maintains a looping of the cable 120 to accommodate the pivot range 148 and eliminate excessive tension on the cable 120. The fixed portion 122 of the cable 120 is routed through or alongside the elongated arm 110, and extends from the distal end 112 of the arm 110, where the free portion 124 of the cable 120 includes a coiled section 128 for maintaining ground clearance when the cable 120 is not engaged. When the cable 122 is between uses, a base receptacle 184 secures and protects the charge connector 126.

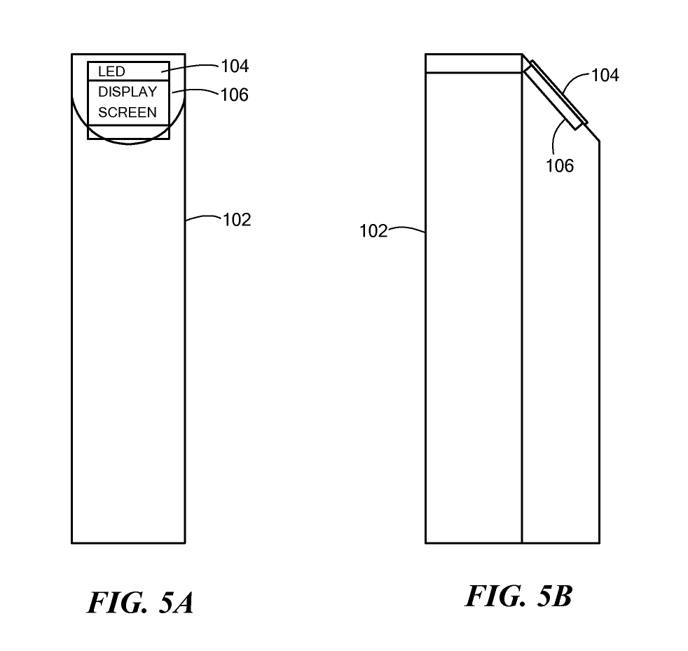

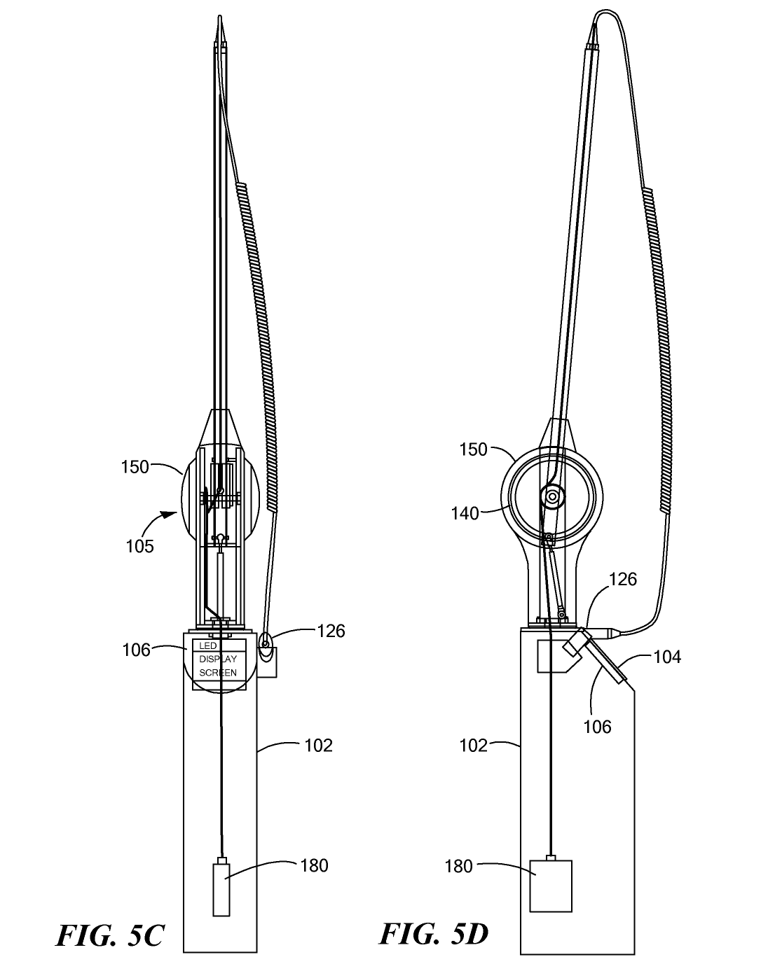

FIGS. 5A-5D show a stand-alone mounting base of the main assembly of FIG. 2A. Referring to FIGS. 5A-5D, in a particular configuration, the mounting base 102 may be made of any suitable support material, such as concrete, steel, or composite materials. A hollow center or core allows routing of the cable 120 and related components such as the grid connection 180. A display screen 104 for a user interface is mounted on an angled top surface 106 that sheds precipitation and provides a better viewing angle. The mounting post 102 is approximately the same width as the cantilever support 150, to avoid unnecessary bulk or overhang which might increase likelihood of damage from passing objects. The user interface provided by the display screen 104 is intended primarily for operational user feedback, An additional screen 105 on the round face of the cantilever support 150 that is more visible then 104 when the station is in use be employed for other information and feedback such as news, weather, traffic, charger reservation identification, time to full charge, advertising for increased revenue, station instructions, station status, operator information for problems, special events, car side diagnostics from vehicle once connected, emergency information or public announcements, and to indicate charge is over and connector can be moved to another vehicle.

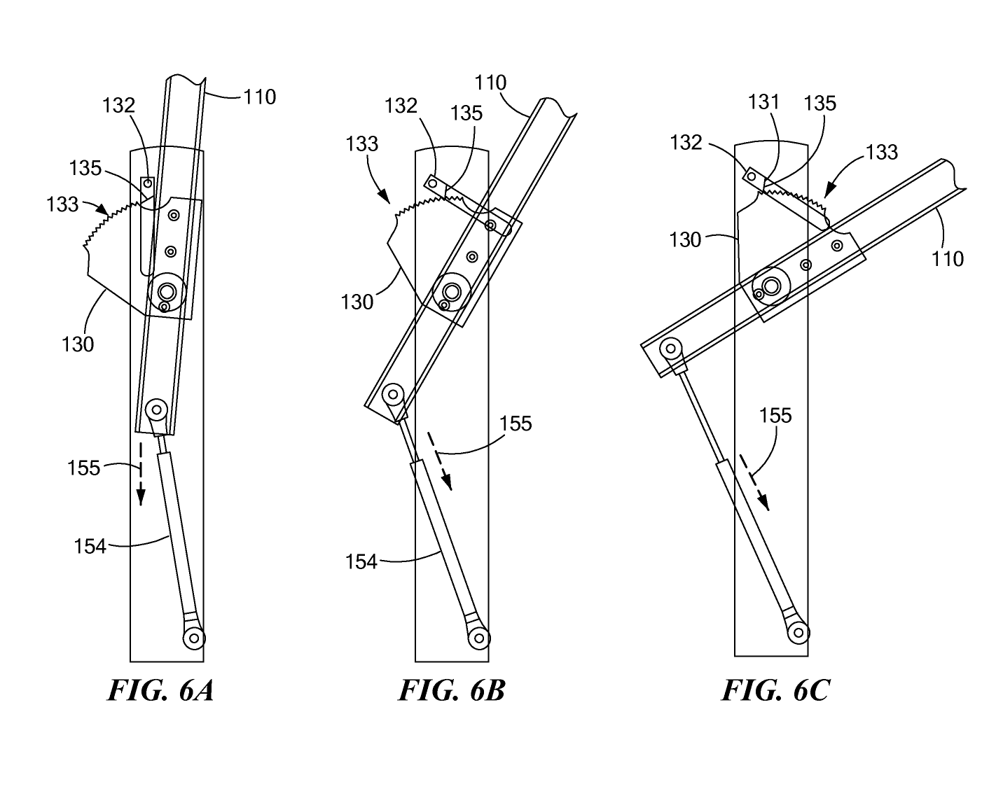

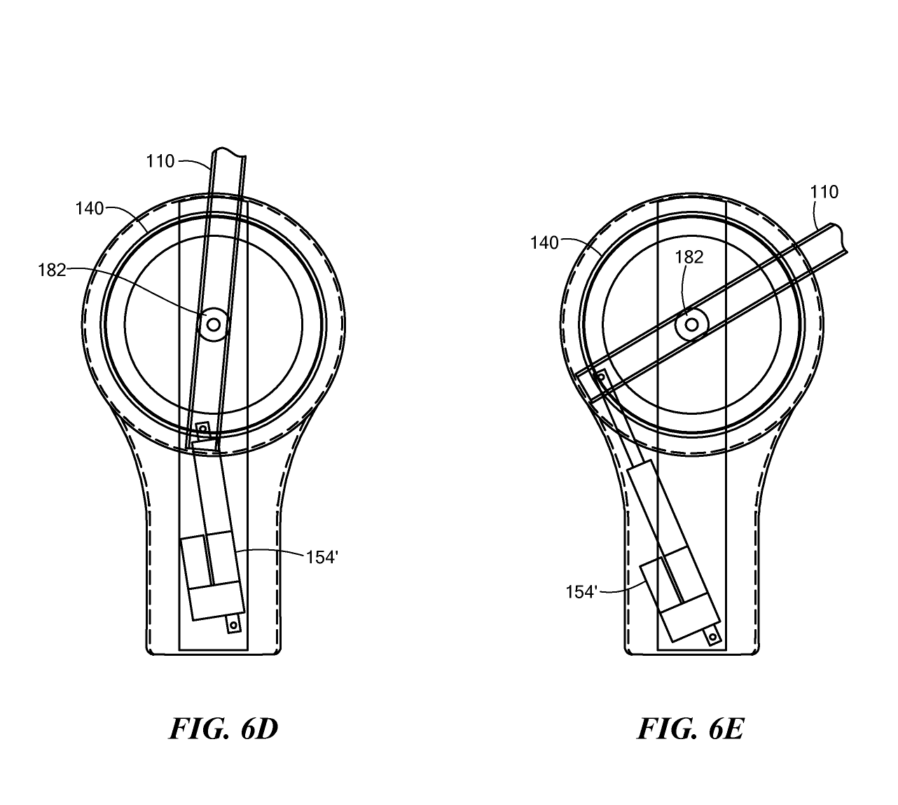

FIGS. 6A-6E show the counterbalance of the cantilever support of FIG. 3A in more detail. Referring to FIGS. 6A-6C, a progression of elongated arm 110 pivoting is shown, corresponding to the positions of FIGS. 3A-3D. At an uppermost retracted (near vertical) position, the elongated arm 110 stands approximately 5° from vertical. The locking cam 130 is disengaged, and the cam dog 132 hangs freely. Upon extension of the elongated arm 110 to 30°, shown in FIG. 6B, cam teeth 133 on the locking cam 130 dispose the cam dog 132 and latch 135. Upon stopping of downward motion of the elongated arm, or attempted retraction to vertical, the latch 135 engages the cam teeth 133 for preventing unwanted upward motion. Recall that, as discussed above, the elongated arm 110 maintains a slight upward bias, thus if a user releases the elongated arm 110, the upward tendency of the arm 110 would result in engagement of the latch 135 with the cam teeth and lock the arm 110 from further upward movement.

Various configurations provide similar operation. The cantilever support may employ a drive mechanism for pivoting the elongated arm. In this configuration, the cantilever support is responsive to the drive mechanism for motive force through the pivot range, such that the drive mechanism is responsive to a control signal for disposing the elongated arm through the pivot range. The drive mechanism may also include a retention mechanism on the elongated arm, such as a physical brake or simply inherent resistance in the drive mechanism, such that the retention mechanism supports the elongated arm in equilibrium so that the interface experiences no bias from the elongated arm. Equilibrium in the elongated arm fixes the arm so that a connection or coupling of the interface to a receptacle, such as a charge or fluid coupling, does not unduly strain of damage the connector from “pulling” from the elongated arm. This operational and nondestructive communication with the receptacle ensures continued, reliable operation through multiple usage cycles.

In particular configurations, the ratchet mechanism may be replaced by friction mechanisms (clutches) or other common position maintaining mechanisms, thus friction can be obtained using opposing plates or drums or by using belts.

Upon full downward deployment, shown in FIG. 6C, the cam teeth 133 have progressed near the maximum engaging position of the latch 135. After the last tooth position, the cam dog 132 is released and swings back to a free hanging position. The cam teeth 132 will now slideably pass the latch 135 due to the angled surface 131 of the cam dog 132, until the elongated arm 110 retracts completely as in FIG. 6A and begins the engaging cycle again. In this manner, a user deploying the elongated arm 110 will only be able to move the arm on a downward arc toward a charge receptacle, until a full downward travel of the pivot range 148 is achieved, at which point the cam latch 135 disengages and the elongated arm 110 returns to the upward, undeployed (home) position (FIG. 6A) by the upward bias provided by the counterbalance 154.

The counterbalance 154, shown as a gas spring but could also be a coiled spring, hydraulic cylinder, linear actuator as discussed below in FIGS. 6D-6E, or other suitable apparatus for exerting counterforce on the elongated arm 110, that exerts a force slightly greater than the downward gravitational force on the elongated arm 110 and attached cable 120, shown by arrow 155. This force 155 provides a slight upward bias to the elongated arm 110 and cable 120, allowing user displacement with minimal effort to pull the elongated arm 110 downward by overcoming the bias. The upward bias is therefore limited by the locking cam 130 until released by the user or at the end of elongated arm 110 travel through the pivot range 148. The linear actuator 154′, however, is responsive to control signals such as from the display screen 104, for remote and effortless pivoting of the elongated arm 110 through the pivot range 148. Further, the linear actuator 154′ may be responsive to key fob controls typically employed for vehicle locking, unlocking, remote start, and other intrinsic vehicle functions.

Alternate configurations include a brake or retention mechanism on the cantilever support such as a pin or compression/frictional linkage. The brake supports the elongated arm in equilibrium, or fixed in response to a motive drive force, such that the coupling experiences no upward or downward force from the upward bias, thus relieving external “pulling” on the coupling or connector that can compromise the fitting. The brake is responsive to a completion signal, such as an end of charge signal. The completion signal indicative of completion of the engagement of the coupling, whether it be end of charge or completion of a liquid fuel filling, for example.

The completion signal disengages the brake and allows the upward bias to return the elongated arm to the rest position, thus providing an automatic retraction upon charge completion. The brake may take the form of a solenoid engagement on the arm to relieve cable strain. The brake may be any suitable fixing appliance, such as a solenoid pin engaged with the elongated arm for fixing the arm such that the coupling engages the receptacle. An ejection mechanism would also be integrated into the coupling where required so it first disengages from the connection point before the upward bias is activated to return the pole to the vertical position. In a setting where a charge station is accessible by multiple locations (i.e. vehicle parking spaces), this allows another vehicle to use the charging station without leaving the cable plugged into a charged vehicle pending return of the owner. Otherwise, parked, charged vehicles continue to monopolize the charge station until the owner returns and manually disengages the charge connector.

FIGS. 6D and 6E show a linear actuator 154′ or other linear drive mechanism as the counterbalance 154. The linear actuator 154′ allows electrically driven movement to facilitate usage. As with the spring piston of FIGS. 6A-6C, the linear actuator 154′ disposes the elongated arm 110 around the rotation track 140. The linear drive would be activated by a switch on the station, by a switch that detects the user is pulling on the cable 120 or by the user initiating a charge session. The linear drive will then tilt the unit out until the user stops the forward switch or a predetermined point based on a user profile. The retraction can be done when the connector is removed from the vehicle/device, or when the user operates a retraction switch or the connector is docked into the station base. In such a configuration, the cam 130, dog 132, gas spring, and shock absorber can be replaced with the linear drive mechanism 154, which provides for little or no force on the cable/hose/connection point during deployment and use.

In a particular configuration, when employed for charging and/or transfer with an electric vehicle, the charging station is operable to identify an approaching vehicle, and optionally, the identity thereof. The elongated arm automatically lowers to a position from which the charge receptacle is accessible. Thus, the charge station deploys the elongated arm in response to a control signal, such as from a key fob or RFID (Radio Frequency ID) on the EV 30, in which the deployment is operable to pivot the elongated arm to a predetermined lowered position. The user connects the charge cable, and in the event of user non-presence at charge completion, the charging station detects completion of a charging operation resulting from the transfer with the electric vehicle, disengages, in response to the detecting completion, the charge coupling from the receptacle by disconnecting the charge coupling, such as via a solenoid based latch or protrusion, and returns the elongated arm to an undeployed rest position at an upper end of the pivot range.

In a particular configuration, following return to the undeployed position, the charging station may secure the charge coupling to a fixed position by remote engagement, such as via a magnetic attraction or a moving hook, to secure the charge connector from free hanging or swinging where it might be a hazard to passersby.

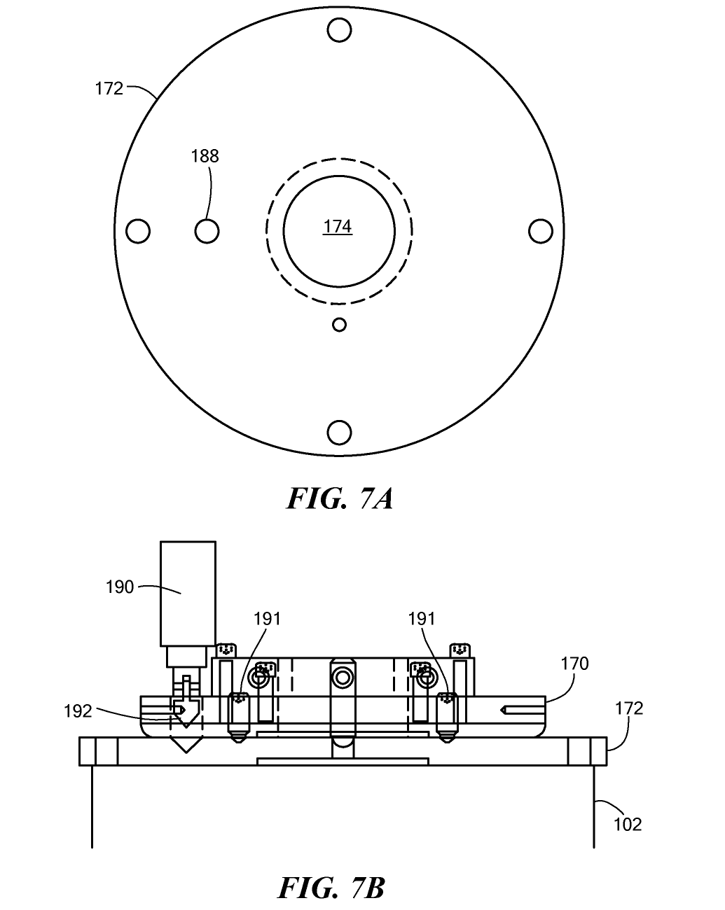

FIGS. 7A-7B show the rotation plate of FIG. 5A in more detail. Referring to FIGS. 4A-4B and 7A-7B, the rotation of the cantilever support 150 is shown in more detail. Referring to FIGS. 4A-4B and 7A-7B, the base plate 172 employs positional detents 186 and a home detent 188. Positional detents are adapted to be engaged by spring biased pins 191 on the rotation plate, for frictionally maintaining positions of arm 110 rotation that are overcome by additional force, such as a user moving from a side position parallel to a curb to a position overhanging the EV 30. Further, the home position, in addition to detent 189 selection, also employs a home positioning solenoid 190 and corresponding home position detent 188. The home position corresponds to an idle position when the elongated arm 110 is not connected to an EV 30 for charging, and is intended to be minimally intrusive to the surroundings, such as sideways facing for a curb mount, or centered forward for a parking lot mount. In the home position, the solenoid 190 drives a solenoid pin 192 through the home rotation detent 188 and into a fixed position in a home recess 194, therefore fixing the rotation plate 172 until disengagement. Further, the pivoting mechanism may provide tampering resistance from a pin or containment mechanism interlocked with the rotational plate 170 and/or locking cam to 130 hold the pole in the vertical home position until a charging session is initiated.

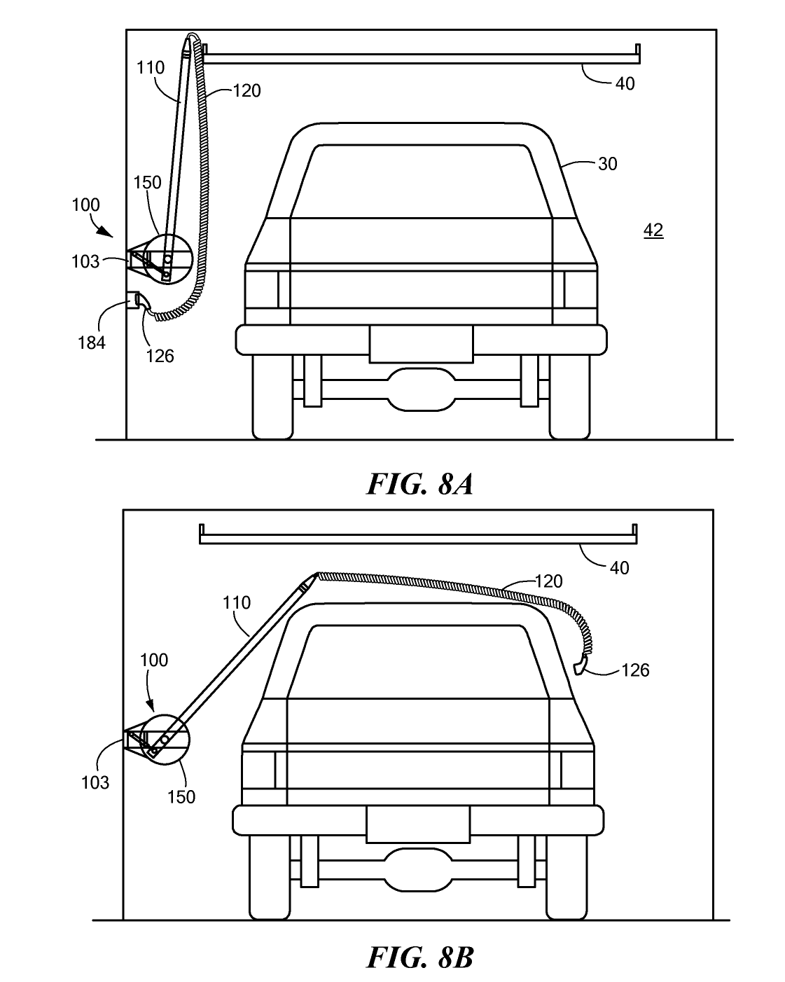

FIG. 8A-8B show a wall mount configuration of the cantilever support as an alternative to FIG. 5A. In addition to a curbside or parking lot mount in public spaces, the cable handler 100 also has application in domestic environments such as a garage 42 wall or ceiling. Still further, the vertical or pole mount may facilitate installation to existing poles or street fixtures by the mounting system can be a collar that bolts around the pole. The mechanism will then attach to the collar and will slide around the collar to reach vehicles.

Referring to FIGS. 1A-1C and 8A-8C, in alternate configurations, the cable handler device 100 is implemented with a wall mount 103 instead of the mounting pole 102, such as in a residential garage 42. In such a setting, the elongated arm 110 maintains clearance between a garage door 40 as well as the general garage 42 structure. The charge connector 126 is disposed across or around the EV 30, such that the elongated arm 110 is disposed above the EV 30 in the clearance between the vehicle 30 and the garage door 40.

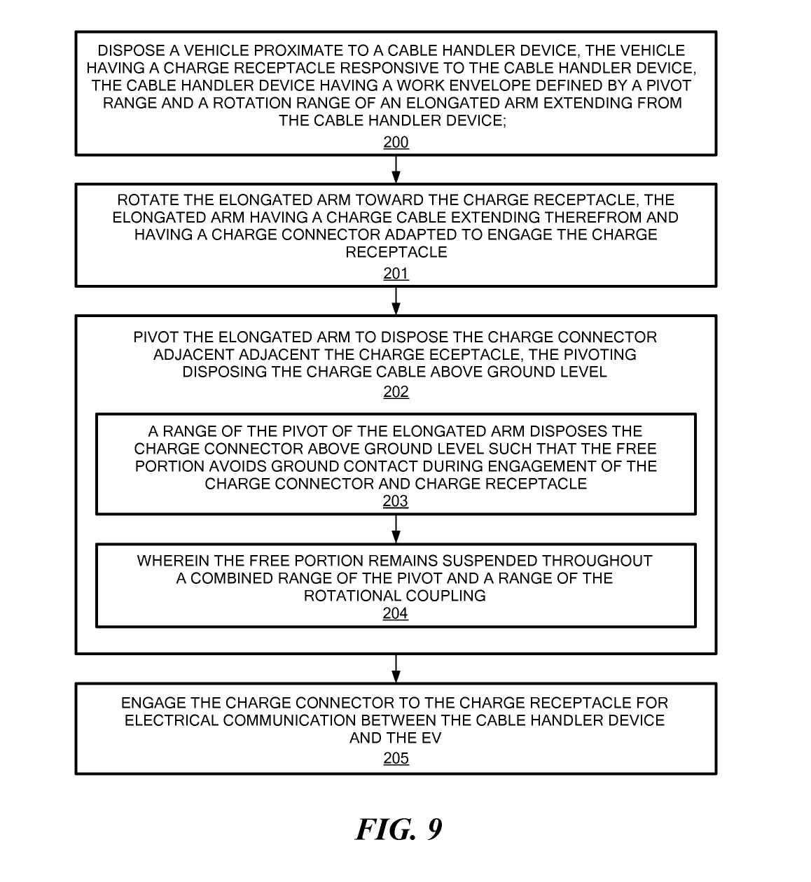

FIG. 9 shows a flowchart of deployment of the cable handling device for charging a battery of an electric vehicle, as disclosed above. Referring to FIGS. 1A-1C and 9, In a particular configuration, the method for charging a battery of an electrical vehicle (EV) 30 includes, at step 200, disposing a vehicle 20 proximate to a cable handler device 100, in which the vehicle has a charge receptacle 30 responsive to the cable handler device 100, and the cable handler device 100 has a work envelope defined 160 by a pivot range 148 and a rotation arc 149 of an elongated arm 110 extending from the cable handler device 100. The user rotates the elongated arm 110 toward the charge receptacle 30 of the EV, in which the elongated arm 110 has a charge cable 120 extending therefrom and also has a charge connector 126 at the end of the cable 120 adapted to engage the charge receptacle 30, as depicted at step 201. The user pivots the elongated arm 110 downward to dispose the charge connecter 126 adjacent the charge receptacle 30, such that the pivoting disposing the charge cable only above ground level without allowing the charge connector 126 or the cable 120 to rest on the ground, as shown at step 202.

A range of the pivot 148 of the elongated arm 110 disposes the charge connector 126 above ground 40 level such that the free portion 124 avoids ground contact during engagement of the charge connector 126 and charge receptacle 30, as depicted at step 203. The free portion 124 remains suspended throughout a combined range of the pivot 148 and a range of the rotational coupling, or rotation arc 149, as shown at step 204. The allowable range of movement of the free portion 124 and charge connector 126 defines the work envelope 160 of connection to the charge receptacle 30. Avoidance of ground contact, therefore, prevents abrasion and wear, as well as a trip hazard, resulting from cables and connectors strewn around the area of the cable handler 100.

The user then engages the charge connector 126 to the charge receptacle 30 for electrical communication between the cable handler device 100 and the EV 20, as depicted at step 205. The cantilever support 150 is adapted to return the elongated arm 110 to a rest position when the charge connector is not engaged, such that the rest position suspends the free portion above ground level. In particular configurations, the cantilever support further comprises a ratchet mechanism such as the locking cam 130, in which the ratchet mechanism is for suspending the elongated arm at successive increments of downward pivoting, and return the elongated arm to a rest position upon release of the ratchet mechanism.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A cable handler device comprising:
an elongated arm pivotally attached to a base, the arm adapted to dispose a distal end vertically in response to the pivot;
a cable secured to the arm, the cable having an interface, the cable having a fixed portion secured substantially parallel to the elongated arm and a free portion extending from the distal end of the elongated arm, the interface disposed on the free portion; and
a cantilever support between the arm and the base for supporting the elongated arm, the cantilever support reducing external force needed to pivot the arm, the cable adapted for communicative transfer via the interface.

2. The device of claim 1 wherein the cantilever support offsets a weight of the elongated arm and the cable for at least partially reducing an external force for pivoting the elongated arm.

3. The device of claim 2 wherein the cantilever support includes a counterbalance for exerting a force slightly greater than the weight of the elongated arm and charge cable such that a slight upward bias is maintained in the elongated arm.

4. The device of claim 3 wherein the cantilever support is adapted to return the elongated arm to a rest position when the coupling is not engaged, the rest position suspending the free portion above ground level.

5. The device of claim 2 further comprising a drive mechanism, the cantilever support responsive to the drive mechanism for motive force through a pivot range, the drive mechanism responsive to a control signal for disposing the elongated arm through the pivot range.

6. The device of claim 5 further comprising a retention mechanism on the elongated arm, the retention mechanism supporting the elongated arm in a fixed position.

7. The device of claim 2 further comprising a retention mechanism on the elongated arm, the retention mechanism supporting the elongated arm at a fixed position in equilibrium against the upward bias such that the coupling experiences no upward force from the upward bias.

8. The device of claim 7 wherein the fixed position mitigates cable tension resulting from pivoting force of the elongated arm on the cable.

9. The device of claim 7 wherein the fixed position is defined by predetermined points for stationary equilibrium such that the interface experiences no bias from the elongated arm.

10. The device of claim 6 wherein the equilibrium disposes the interface in communication with a receptacle for transfer such that the elongated arm remains fixed for maintaining operational and nondestructive communication of the interface with the receptacle.

11. The device of claim 3 wherein the upward bias permits operational and nondestructive communication of the interface with the receptacle.

12. The device of claim 10 wherein the drive mechanism and retention mechanism are responsive to a completion signal, the completion signal indicative of completion of the communicative transfer, further comprising:
disengaging the retention mechanism for allowing the drive mechanism to retract the elongated arm to the rest position; and
disengaging the interface from coupling with the receptacle.

13. The device of claim 1 wherein the interface is a charge coupling adapted for electrical communication with a receptacle responsive to the charge connector for transfer with an electric vehicle, and the cable is a charge cable adapted for electrical conduction.

14. The device of claim 13 wherein the charge coupling is operable for multi-way transfer between battery supporting a vehicle propulsion mechanism and a grid interconnection responsive to excess charge from the battery.

15. The device of claim 13 wherein the free portion is sufficiently limited in length such that ground contact is avoided when the elongated arm is disposed to a maximum lowered position, such that the free portion remains suspended throughout a range of the pivot.

16. The device of claim 15 wherein the cantilever support is further operable for:
deploying the elongated arm in response to a control signal, deployment operable to pivot the elongated arm to a pre determined lowered position; and
returning the elongated arm to an undeployed rest position at an upper end of the pivot range.

17. The device of claim 13 further comprising an automatic retraction mechanism, operable to:
detect completion of a charging operation resulting from the transfer with the electric vehicle; and
disengage, in response to the detecting completion, the charge coupling from the receptacle.

18. The device of claim 16 wherein the base is further operable to, following return to the undeployed rest position, secure the charge coupling to a fixed position by remote engagement.

19. The device of claim 1 further comprising a rotational coupling between the cantilever support and the base, the rotational coupling adapted for disposing the arm through a horizontal arc defined by the extended distal end for disposing the interface into coupling for communicative transfer.

20. The device of claim 13 further comprising:
a base proximate to a plurality of parking spaces; and
a rotational coupling adapted to dispose the elongated arm for engaging the charge connector with a receptacle on an EV in each of the plurality of parking spaces, the elongated arm further operable to maintain the cable substantially overhead for each of the plurality of parking spaces.

21. The device of claim 1 wherein the cantilever support is adapted to maintain the elongated arm disposed substantially overhead of passersby through a range of pivot of the elongated arm.

22. The device of claim 2 wherein the cantilever support offsets the weight of the elongated arm using at least one of a counterweight, gas cylinder or spring for exerting upward force against a weight of the elongated arm and the cable.

23. The device of claim 7 wherein the retention mechanism is operable for disposing the elongated arm in a fixed position using at least one of a counterweight, ratchet, friction plate, magnetic brake or detent.

24. The device of claim 2 wherein an upward bias of the cantilever support disposes the interface in communication with a receptacle for transfer such that the elongated arm remains fixed for maintaining operational and nondestructive communication of the interface with the receptacle.

25. The device of claim 5 wherein the motive force is provided by at least one of a fluidic pressure, pneumatic, hydraulic, belt drive, worm drive, rack-and-pinion, ball screw, gear box, gear drive, magnetic actuator, linear actuator, or electric motor.

26. The device of claim 25 wherein the cantilever support further comprises a retention mechanism, the retention mechanism operable to suppress the motive force and secure the elongated arm and the interface in communication with a receptacle for transfer such that the elongated arm remains fixed for maintaining operational and nondestructive communication of the interface with the receptacle.

27. The device of claim 1 wherein the cable is a conduit for fluidic transfer from a dispensing station, the conduit withstanding pressure of the fluidic transfer and the receptacle configured to engage the coupling for pressure driven transfer of the fluid.

28. The device of claim 1 wherein a range of the pivot of the elongated arm disposes the coupling substantially above ground level such that the free portion avoids ground contact during engagement of the coupling and the receptacle.

29. The device of claim 1 further comprising an articulated coupling on the elongated arm, the articulated coupling for disposing the coupling to the receptacle such that the free portion remains substantially suspended between the elongated arm and the receptacle.

30. The device of claim 1, further comprising a breakover coupling for maintaining rigid coupling until a predetermined level of excessive force is applied, and returning to the rigid coupled state upon cessation of the excessive force.

31. The device of claim 1, further comprising a breakaway attachment adapted to provide a predetermined point of detachment of the elongated arm, the point of detachment selectively severing at least a portion of the elongated arm upon excessive pressure, the selective severing including a clean disengagement of electrical conduction such that electrical terminals are unexposed.

32. A method for charging a battery of an electrical vehicle (EV), comprising:
disposing a vehicle proximate to a cable handler device, the vehicle having a charge receptacle responsive to the cable handler device, the cable handler device having a work envelope defined by a pivot range and a rotation arc of an elongated arm extending from the cable handler device;
pivoting the elongated arm to dispose the charge connecter adjacent the charge receptacle, the pivoting disposing the charge cable above ground level; and
engaging the charge connector to the charge receptacle for electrical communication between the cable handler device and the EV.

33. A charging station for an electric vehicle comprising:
an elongated arm pivotally attached to a base, the arm adapted to move in proximity to a charge receptacle for electric communication with the electric vehicle;
a charge connector at a distal end of a charge cable suspended from the elongated arm, the charge connector adapted to engage the charge receptacle; and
a cantilever support for exerting a force slightly greater than the weight of the elongated arm and charge cable such that a slight upward bias is maintained in the elongated arm.
